(19) United States
(12) Patent Application Publication
(10) Pub. No.: US 2012/0036045 A1
(43) Pub. Date: Feb. 9, 2012

(54) Methods and Systems for Reserving and Completing Purchases

(76) Inventors: William Patrick Lowe, East Twickenham (GB); Oran Kelly, Dublin (IE)

(21) Appl. No.: 13/204,007

(22) Filed: Aug. 5, 2011

Related U.S. Application Data
(60) Provisional application No. 61/371,787, filed on Aug. 9, 2010.

(51) Int. Cl. G06Q 20/00; G06Q 30/00

(52) U.S. Cl. 705/26.44

(57) ABSTRACT

A method of reserving and completing purchases includes transmitting, by a first computing device, a payment authorization code to a second computing device, the payment authorization code associated with an order placed by a user of the second computing device. The method includes receiving, by a transaction management component executing on a third computing device, the payment authorization code from the second computing device. The method includes requesting, by the transaction management component, from the user, a payment to complete the order within a time period. The method includes determining, by the transaction management component, that the user provided the requested payment within the time period. The method includes instructing, by the transaction management component, a retailer transaction management component executing on the first computing device to fulfill the order, responsive to the determination.

### CROSS-REFERENCE TO RELATED APPLICATIONS

This application claims priority from U.S. Provisional Patent Application Ser. No. 61/371,787, filed on Aug. 9, 2010, entitled “Methods and Systems for Providing Consumers with Codes for Authorizing Payment Completion,” which is hereby incorporated by reference.

### BACKGROUND

The disclosure relates to consumer purchases. More particularly, the methods and systems described herein relate to reserving and completing purchases.

Conventional checkout processes typically include several requirements relating to the processes of signing up for a service, identifying funding sources and transferring funds, and completing checkout processes. For example, typical checkout processes conventionally burden both payors—requiring an active sign-up effort as opposed to auto-creation of a new account, for example—and payees.

### BRIEF SUMMARY

In one aspect, the system offers a pay-later functionality on the basis of payment codes being in the “claimed” state for set periods of time; such a pay-later system affords the ability to the payor to buy items from multiple online payees with one payment transaction. In another aspect, the methods and systems described herein include a payment mechanism allowing 1) payees to allocate unique payment codes to shopping baskets, and 2) payors to claim a shopping basket by submitting a payment code, such claims immediately resulting in either payment of the order or reservation of the order for a specified period of time; such a determination dictated by whether the payor has sufficient funds in a payment wallet, and where if reserved, the order is automatically paid if sufficient funds are loaded to the payment account before the reservation expires.

In one aspect, a method of reserving and completing purchases includes transmitting, by a first computing device, a payment authorization code to a second computing device, the payment authorization code associated with an order placed by a user of the second computing device. The method includes receiving, by a transaction management component executing on a third computing device, the payment authorization code from the second computing device. The method includes requesting, by the transaction management component, from the user, a payment to complete the order within a time period. The method includes determining, by the transaction management component, that the user provided the requested payment within the time period. The method includes instructing, by the transaction management component, a retailer transaction management component executing on the first computing device to fulfill the order, responsive to the determination.

In another aspect, a system for reserving and completing purchases includes a first computing device and a transaction management component. The first computing device transmits a payment authorization code to a second computing device, the payment authorization code associated with an order placed by a user of the second computing device. The transaction management component executes on a third computing device. The transaction management component receives, from the second computing device, the payment authorization code and requests, from the user, a payment to complete the order within a time period. The transaction management component determines that the user provided the requested payment within the time period and instructs a retailer transaction management component executing on the first computing device to fulfill the order, responsive to the determination.

In still another aspect, a method of reserving and completing purchases includes receiving, by a transaction management component executing on a first computing device, a plurality of payment authorization codes from a user of a second computing device, each of the plurality of payment authorization codes associated with one of a plurality of orders placed by the user. The method includes requesting, by the transaction management component, from the user, a payment for each of the plurality of orders within a time period. The method includes determining, by the transaction management component, that the user provided the requested payment within the time period. The method includes directing, by the transaction management component, fulfillment of each of the plurality of orders, responsive to the determination.

In yet another aspect, a method of reserving and completing purchases includes receiving, by a transaction management component executing on a first computing device, a plurality of payment authorization codes from a user of a second computing device, each of the plurality of payment authorization codes associated with one of a plurality of orders placed by the user. The method includes requesting, by the transaction management component, from the user, a payment for each of the plurality of orders within a time period. The method includes determining, by the transaction management component, that the user provided a subset of the requested payment within the time period. The method includes identifying, by the transaction management component, one of the plurality of orders that the subset of the requested payment is sufficient to complete. The method includes instructing, by the transaction management component, a retailer transaction management component associated with the identified one of the plurality of orders to fulfill the identified one of the plurality of orders, responsive to the identification. In one embodiment, the method includes applying an algorithm to identify the one of the plurality of orders that the subset of the requested payment is sufficient to complete. In another embodiment, the method includes identifying a second one of the plurality of orders that the subset of the requested payment is sufficient to complete; and instructing, by the transaction management component, a retailer transaction management component associated with the identified second one of the plurality of orders to fulfill the identified second order responsive to the identification. In still another embodiment, the method includes determining that the subset of the requested payment is insufficient to complete a second one of the plurality of orders; and requesting, by the transaction management component, from the user, an additional payment for each unfulfilled order in the plurality of orders within a second time period.

In one aspect, a method of reserving and completing purchases includes receiving, by an account management component executing on a first computer, funding from a user for deposit into a user account. The method includes transmitting, by a second computing device, a payment authorization code to a third computing device, the payment authorization code associated with a first order placed by the user. The method includes receiving, by a transaction management component executing on the first computing device, the payment authorization code from the third computing device; determining, by the transaction management component, that the funding in the user account is sufficient to pay for the first order; and instructing, by the transaction management component, a retailer transaction management component executing on the second computing device to fulfill the first order, responsive to the determination. The method includes providing, by a fourth computing device, to the third computing device, a second payment authorization code associated with a second order placed by the user. The method includes transmitting, by the third computing device, to the transaction management component, the second payment authorization code. The method includes determining, by the transaction management component, that the funding in the user account is insufficient to pay for the second order; requesting, by the transaction management component, from the user, additional funds to complete the second order within a time period; determining, by the transaction management component, that the user provided the requested additional funds within the time period; and instructing, by the transaction management component, a second retailer transaction management component executing on the fourth computing device to fulfill the second order, responsive to the determination.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting one embodiment of a system for reserving and completing purchases;

FIG. 1B is a flow diagram depicting an embodiment of a method for reserving and completing purchases;

FIG. 1C is a flow diagram depicting an embodiment of a method for reserving and completing purchases;

FIG. 1D is a flow diagram depicting an embodiment of a method for reserving and completing purchases;

FIG. 1E is a flow diagram depicting an embodiment of a method for reserving and completing purchases;

FIG. 2 is a block diagram depicting one embodiment of a system for providing consumers with codes for authorizing payment completion via mobile phone communications;

FIG. 3A is a flow diagram depicting one embodiment of a state life-cycle for a transaction;

FIG. 3B is a flow diagram depicts one embodiment of a method for paying for goods or services at a retailer website;

FIG. 3C is a flow diagram depicting one embodiment of a method for paying via mobile phone for a good or service using a product code;

FIG. 3D is a flow diagram depicting one embodiment of a method for refunding a purchaser's authorized payment; and

FIG. 3E is a flow diagram depicting one embodiment of a method for invalidating a checkout transaction.

### DETAILED DESCRIPTION

In some embodiments, the methods and systems described herein provide functionality for dynamically producing payment codes unique to an online “shopping basket” and for allocation of such purchases to mobile-number-denominated accounts upon receipt of a text message containing the payment code, even if no such account previously existed. In one of these embodiments, confirmation of the transaction as paid or reserved is subject to funds validation of the account balance. In another of these embodiments, if a transaction is identified as reserved subject to transfer of additional funds into the account during a specified period of time, and the user provides the additional funds, an auto-payment of reserved transactions occurs.

In some embodiments, the system includes functionality allowing retail users to allocate payment codes with which purchasing users can authorize payment. In other embodiments, the system includes machines executing software such as web services software allowing interaction between the first server, the second server, and the client machine. In still other embodiments, a user of the client machine interacts with the first server and with the second server across one or more computer networks.

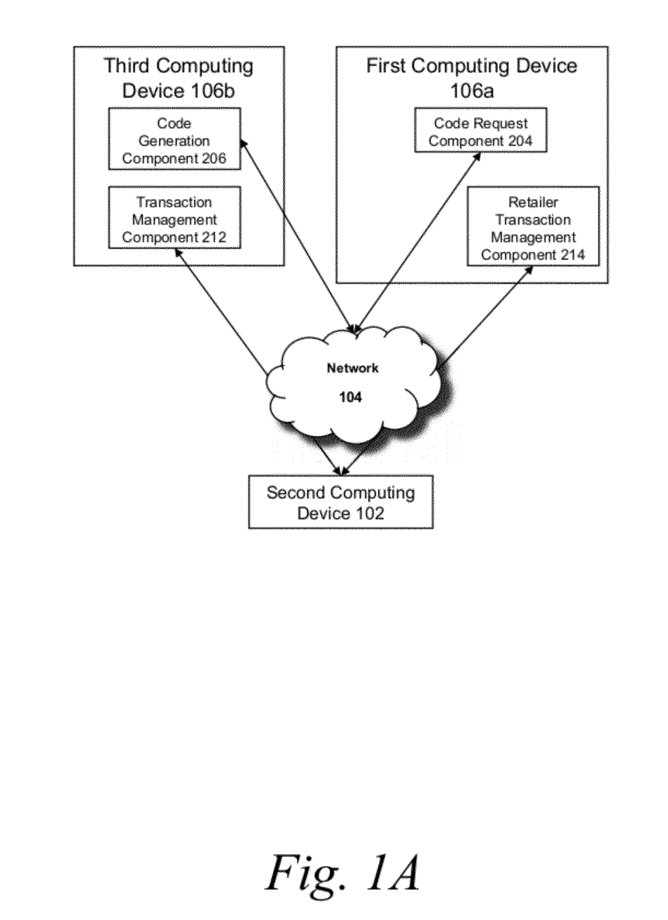

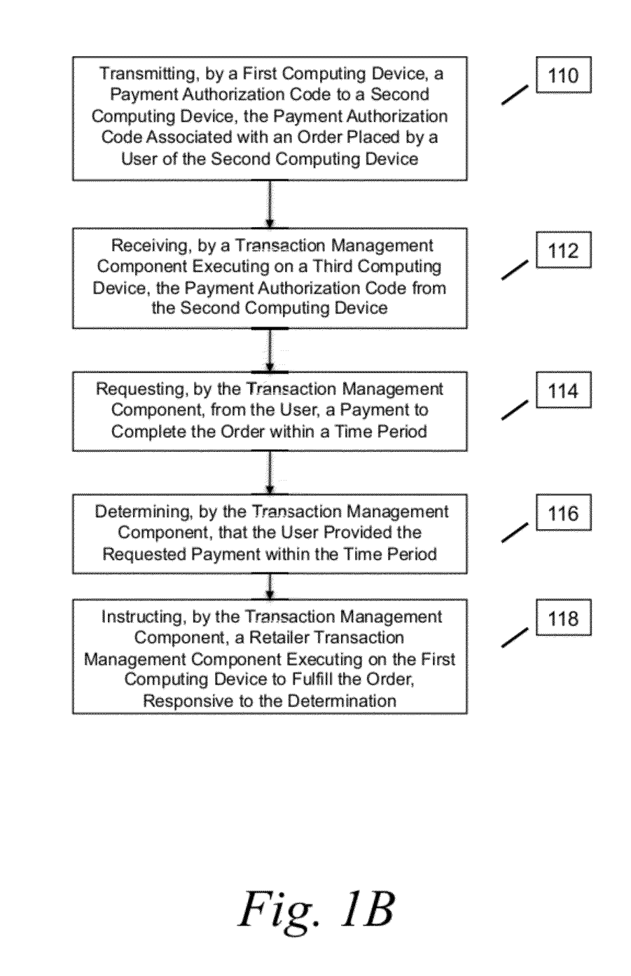

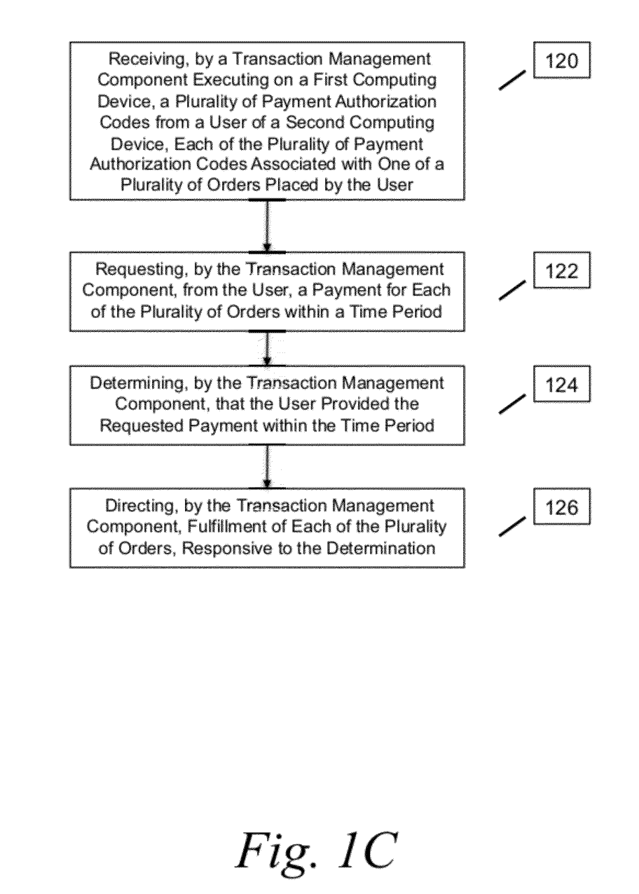

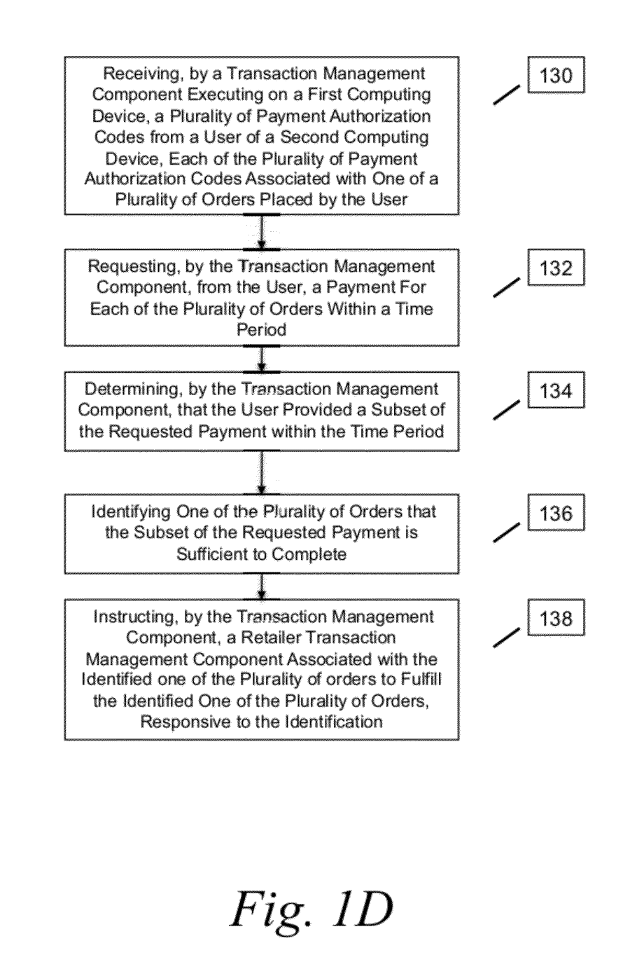

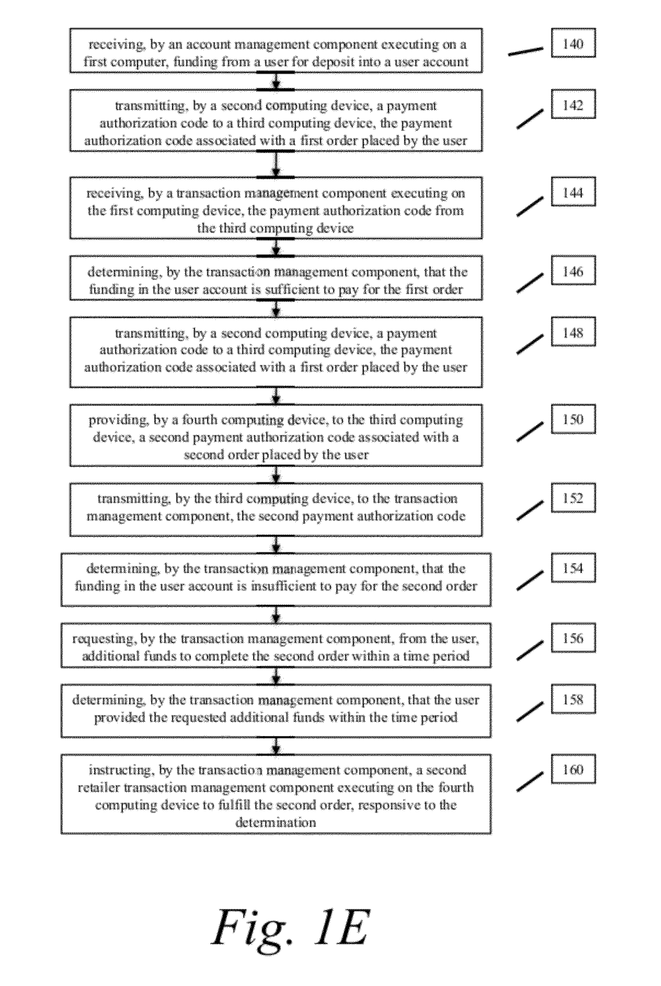

Referring now to FIG. 1A, a block diagram depicts one embodiment of a system for reserving and completing purchases. In brief overview, the system includes a first computing device 106a, a second computing device 102, and a third computing device 106b. In one embodiment, the first computing device 106a includes a code request component 204 and a retailer transaction management component 214. The first computing device 106a transmits a payment authorization code to a second computing device 102, the payment authorization code associated with an order placed by a user of the second computing device 102. In one embodiment, the third computing device 106b includes a code generation component 206 and a transaction management component 212. The transaction management component 212 receives, from the second computing device 102, the payment code. The transaction management component 212 requests, from the user, a payment to complete the order within a time period. The transaction management component 212 determines that the user provided the requested payment within the time period. The transaction management component 212 instructs the retailer transaction management component 214 executing on the first computing device 106a to fulfill the order responsive to the determination.

Referring now to FIG. 1A, and in greater detail, in some embodiments, the first computing device 106a is operated by or on behalf of a retailer selling goods or services to a user of the second computing device 102. In one embodiment, the retailer is a for-profit entity. In another embodiment, the retailer is a non-profit or a not-for-profit entity. In still another embodiment, the retailer is a charitable organization. In some embodiments, a retailer selling goods or services from a physical location, such as a physical store in which the user is shopping, operates the first computing device 106a. In other embodiments, a retailer selling goods or services from an electronic-commerce location on the Internet (e.g., via a web site) operates the first computing device 106a. In further embodiments, the methods and systems described herein may be applied to all remote payment opportunities in which consumer and retailer are not physically present, e.g. mail/telephone order or TV shopping.

In some embodiments, the third computing device 106b includes a module that allocates payment codes to mobile number denominated wallets on receipt of text messages from consumers, and manages codes not claimed or paid. In other embodiments, the third computing device 106b includes functionality to perform at least one of the following: identify incoming messages as either payment codes or other messages; strip out other messages and send elsewhere for processing; allocate payment codes to mobile number denominated consumer wallets; auto creation of wallet when new users text payment code; maintain a database of codes; auto expire payment codes not claimed within reservation window; or auto expire payment codes, claimed but not paid within reservation window.

In further embodiments, the third computing device 106b includes functionality to manage consumer wallet balances and pay all claimed purchases if sufficient funds and pays all reserved purchases, if a top-up event occurs between claim of the purchase and expiration of the reservation window. In one of these embodiments, the third computing device 106b includes functionality to perform at least one of the following: validate wallet cash balance, validate wallet pending transactions (reservations), allocate incoming funds against pending transactions on either a “first in, first out basis”, or a “best fit” basis.

The system includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more computing devices 106a-106n (also generally referred to as server(s) 106, computing device(s) 106, or remote machine(s) 106) via one or more networks 104.

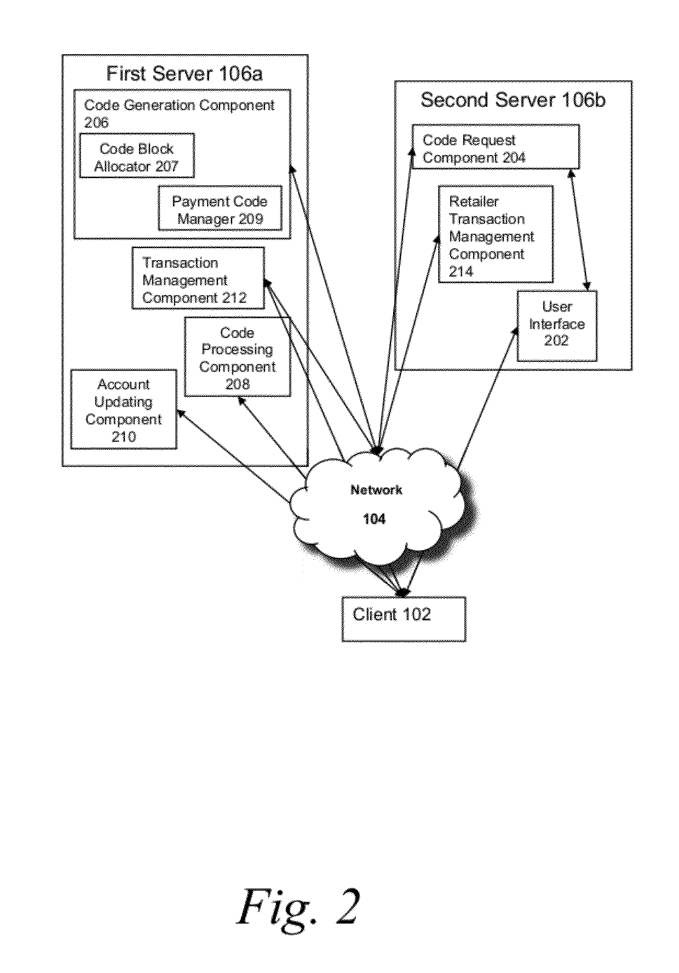

Although only one first computing device 106a, second computing device 102, and third computing device 106b are depicted in the embodiment shown in FIG. 1A (as well as below in FIG. 2), it should be understood that the system may provide multiple ones of any or each of those components. For example, in one embodiment, the system includes multiple, logically-grouped servers 106a, each of which are available to execute one or more code generation components 206, transaction management components 212, code processing components 208, and account updating components 210. The functionality provided by one or more servers 106a may be referred to as a payment system or as a “pay by mobile” system (in embodiments, for example, in which the client 102 is a mobile device).

In one embodiment, a computing device 106 provides functionality of a web server. In some embodiments, a web server 106 comprises an open-source web server, such as the APACHE servers maintained by the Apache Software Foundation of Delaware. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems, of Santa Clara, Calif.

The computing devices 106 may be geographically dispersed from each other or from computing devices 102 and communicate over a network 104. The network 104 can be a local-area network (LAN), such as a company Intranet, a metropolitan area network (MAN), or a wide area network (WAN), such as the Internet or the World Wide Web. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS.

The client 102 and the servers 106 may be deployed as and/or executed on any type and form of computing device, such as a computer, network device or appliance capable of communicating on any type and form of network and performing the operations described herein. Furthermore, the client 102 and the servers 106 may include a network interface 118 to interface to the network 104 through a variety of connections including, but not limited to, standard telephone lines, LAN or WAN links, broadband connections, wireless connections, or some combination of any or all of the above. Connections can be established using a variety of communication protocols. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In one embodiment, a user “claims” a payment authorization code by sending the payment authorization code via a text message (e.g., an SMS or MMS message) to the third server 106b from a mobile phone 102. In some embodiments, a computer 100 (such as a second computing device 102) connects to a second computer 100′ (such as a third computing device 106b) on a network using any one of a number of well-known protocols from the GSM or CDMA families, such as W-CDMA. These protocols support commercial wireless communication services and W-CDMA. In other embodiments, the computer 100′ communicates with a computer 100 when providing a user with a service made available by the Global System for Mobile Communications (GSM) standard. In other embodiments, the computer 100 provides a user with a short message service (SMS). In one of these embodiments, the computer 100 may transmit messages to the second computer 100′ via an intermediate computer 100″, such as a short message service center. In another of these embodiments, the computer 100 may transmit messages to the second computer 100′ according to a telecommunications protocol standard for transmitting digital data on a broadband network, such as the Signaling System 7 (SS7) protocol. In still other embodiments, the computer 100 transmits enhanced short messages to the computer 100′.

In other embodiments, the computer 100 transmits text messages to a computer 100′. In one of these embodiments, the text messages comply with the GSM standard for short messages. In another of these embodiments, the computers 100, 100′ transmit text messages that do not comply with a GSM standard. In still another of these embodiments, the computer 100 transmits text messages over a control channel between the computer 100 and a cell phone tower, which forwards the text messages to the recipient computer 100′.

Referring still to FIG. 1A, the code request component 204 executes on the first computing device 106a and requests, from the third computing device 106b, the payment authorization code. In one embodiment, the code generation component 206 generates the payment authorization code and transmits the payment authorization code to the first computing device 106a.

In some embodiments, a payment authorization code may be referred to as a retail code, a product code or a checkout code. In one of these embodiments, a retail code is a unique code that can be transmitted (e.g., via text message) by a user to a server 106b in order to pay for goods or services; the system may provide a plurality of types of retail codes. In another of these embodiments, the system includes functionality for generating a checkout code, which may be, by way of example, a single-use code created when a server 106a operated by or on behalf of a retailer makes a request for generation of a code by the code generation component 206; for example, a code request component 204 executing on the first server 106a may issue a request according to an application programming interface (API) and transmit the request to the second server 106b. In still another of these embodiments, a checkout code is tied to a specific retailer transaction (for example, to a particular shopping basket). In still even another embodiment, a checkout code cannot be reused. In still another of these embodiments, a product code is a multi-use code created by a retailer via, by way of example, a retailer portal web application for communicating with the second server 106b. In yet another of these embodiments, more than one user can “claim” a product code in order to pay for the goods or services associated with that code.

In one embodiment, a checkout code contains a plurality of alphanumeric characters. For example, and without limitation, the checkout code may contain 9-characters: a sequence of three digits, three alphabetic characters and three digits again (e.g., “821adg213”). In another embodiment, checkout codes are not case-sensitive. sensitive.

In one embodiment, a product code contains a plurality of alphanumeric characters; for example, and without limitation, a product code may include a series of alphabetic characters followed by a series of digits. In another embodiment, each of a plurality of retailers that registers to use product codes is assigned a product code prefix which will make up the alphabetic part of any product code they create; retailers are then free to choose the numeric portion of a created product code. For example, and without limitation, if a retailer's product code prefix is “red”, they can create product codes of the form “red22”, “red1”, “red2010,” etc.

In some embodiments, the third computing device 106b executes an account management component (not shown) receiving from the user of the second computing device 102 account registration information and establishing a user account for the user responsive to the received account registration information. In one of these embodiments, the account management component receives from the user of the second computing device 102 an identification of the second computing device 102 as a device from which the user may access account information associated with the user and stored by the third computing device 106b. In another of these embodiments, the account management component receives from the user of the second computing device 102 an identification of a fourth computing device 102b (not shown) as a device from which the user may access account information associated with the user and stored by the third computing device 106b; in such an embodiment, the account management component may also receive information authentication the fourth computing device 102b to the third computing device 106b. The account management component may be provided as an account updating component 210 described in greater detail below, in connection with FIG. 2.

Referring now to FIG. 1B, a flow diagram depicts one embodiment of a method of reserving and completing purchases. In brief overview, the method includes transmitting, by a first computing device, a payment authorization code to a second computing device, the payment authorization code associated with an order placed by a user of the second computing device (110). The method includes receiving, by a transaction management component executing on a third computing device, the payment authorization code from the second computing device (112). The method includes requesting, by the transaction management component, from the user, a payment to complete the order within a time period (114). The method includes determining, by the transaction management component, that the user provided the requested payment within the time period (116). The method includes instructing, by the transaction management component, a retailer transaction management component executing on the first computing device to fulfill the order, responsive to the determination (118).

In some embodiments, a user is not required to have a user account in order to pay for transactions with one or more retailers. In one of these embodiments, when a retailer requests generation of a code and initiation of a checkout transaction process on behalf of a consumer who does not yet have a user account, a new account is established on behalf of the user and the user is given the opportunity to top up the account when they claim the code. In another of these embodiments, the methods and systems described herein provide a user with the ability to push funds on to an account as opposed to registering automatic “pull funding” that could require a pre-registered account.

Referring still to FIG. 1B, and in conjunction with FIG. 1A, the first computing device 106a transmits, to the second computing device 102, a payment authorization code associated with an order placed by a user of the second computing device (110). In one embodiment, the code request component 204 executing on the first computing device 106a receives the payment authorization code from the third computing device 106b. In another embodiment, the code request component 204 receives the payment authorization code from the code generation component 206 executing on the third computing device 106b.

In one embodiment, a user of the second computing device 102 receives a payment authorization code from the first computing device 106a. In another embodiment, the user of the client 102 transmits the payment authorization code to the first server 106a with an authorization to transfer a payment to the second server 106b. For example, the user of a personal computing device may receive a payment authorization code from a first web site accessed via the client 102 and transmit the payment authorization code to the first server 106a from a second web site accessed via the client 102. Alternatively, and as another example, the user of the client 102 (which may be a mobile phone) may transmit a text message containing the payment authorization code to the first server 106a. In still another embodiment, the user of the client 102 accesses a second client 102b and uses the second client 102b to transmit the received payment authorization code to the first server 106a. In yet another embodiment, and by way of example, a first client 102a may be a personal computing device, such as a laptop or desktop computer, and the user of the first client 102a accesses the second server 106b via the first client 102a (for example, and without limitation, by executing a web browsing application on the first client 102a); the second client 102b may be a second personal computing device, such as a laptop or desktop computer or a mobile computing device, such as a mobile phone or personal digital assistant, with which the user transmits the payment authorization code to the first server 106a.

The transaction management component 212 receives the payment authorization code from the second computing device 102 (112). In other embodiments, a code processing component receives the payment authorization code.

In one embodiment, the transaction management component 212 transmits, to the retailer transaction management component 214, a notification of receipt of the payment authorization code from the second computing device 102. In another embodiment, the transaction management component 212 transmits, to the retailer transaction management component 214, a notification of a change in status of a transaction (e.g., from pending to claimed or from claimed to paid). In some embodiments, upon receiving the payment authorization code from the second computing device 102, the transaction management component 212 directs the establishment of a new account for the user of the second computing device 102.

The transaction management component 212 requests, from the user, a payment to complete the order within a time period (114). In some embodiments, the retailer specifies the time period. In other embodiments, an administrator of the first server 106a establishes the time period.

The transaction management component 212 determines that the user provided the requested payment within the time period (116). The transaction management component 212 instructs a retailer transaction management component executing on the first computing device to fulfill the order, responsive to the determination (118). In one embodiment, the transaction management component 212 transfers a subset of the requested payment to an account associated with an owner of the first computing device 106a (e.g., the retailer fulfilling the order placed by the user.

In some embodiments, a user may transmit, to the third computing device 106b, an identification of a fourth computing device 102b. For example, the second computing device 102 may transmit the identification to an account management component executing on the third computing device 106b. In one of these embodiments, the third computing device 106b maintains the identification of the fourth computing device 102b for use in the event that the user later reports that the first computing device 102 has been lost or stolen. In another of these embodiments, upon verification of the loss of the first computing device 102, the third computing device 106b associates the user account information, the user's “wallet” and other relevant data with the identification of the fourth computing device 102b. In other embodiments, when a user reports the first computing device 102 as lost or stolen, the third computing device 106b locks the account to prevent future payments from being made on behalf of unauthorized users.

In one embodiment, a user is asked to provide an email address prior to registering a fourth computing device 102b. In some embodiments, a user registers the fourth computing device 102b using an interactive voice response technology. In other embodiments, a user registers the fourth computing device 102b using a web-based customer portal. In still other embodiments, a user registers the fourth computing device 102b using an SMS command.

In one embodiment, once a fourth computing device 102b is registered, a user of the fourth computing device 102b may initiate a “pull” transfer using an SMS command that identifies the first computing device 102. In another embodiment, upon receipt of this command, the third computing device 106b makes the user's account (“wallet”) available via the fourth computing device 102b. In still another embodiment, the third computing device 106b sends a message (e.g., an e-mail) to a registered email address provided by the user. In still even another embodiment, this message includes information with which the user of the fourth computing device 102b may activate access to the account information; for example, an email may be sent that includes an activation link (URL) which the owner of the wallet access before any funds are accessed via the fourth computing device 102b. A user may decide to use the activation link or not to use the activation link (instead choosing, for example, to access data from the fourth computing device 102b). If they do click the link then the funds are transferred to a wallet associated with the fourth computing device 102b while the funds accessible via the first computing device 102 remain in a locked state.

Referring now to FIG. 1C, a flow diagram depicts one embodiment of a method of reserving and completing purchases. In brief overview, the method includes receiving, by a transaction management component executing on a first computing device, a plurality of payment authorization codes from a user of a second computing device, each of the plurality of payment authorization codes associated with one of a plurality of orders placed by the user (120). The method includes requesting, by the transaction management component, from the user, a payment for each of the plurality of orders within a time period (122). The method includes determining, by the transaction management component, that the user provided the requested payment within the time period (124). The method includes directing, by the transaction management component, fulfillment of each of the plurality of orders, responsive to the determination (126).

In one embodiment, implementation of the methods and systems described herein allow a user to pay for transactions provided by a plurality of retailers. In another embodiment, and by way of example, a user may make a first transaction with a first retailer, authorize the transfer of funds from the user wallet to the first retailer, make a second transaction with a second retailer, and authorize the transfer of funds from the user wallet to the second retailer. In still another embodiment, a user may make a first transaction with a first retailer, make a second transaction with a second retailer, and then make a single funds transfer to the user account (the wallet) that will be used for payment of both transactions.

Referring still to FIG. 1C, and in conjunction with FIG. 1A, the transaction management component 212 receives a plurality of payment authorization codes from a user of a second computing device, each of the plurality of payment authorization codes associated with one of a plurality of orders placed by the user (120). The transaction management component 212 requests, from the user, a payment for each of the plurality of orders within a time period (122). The transaction management component 212 determines that the user provided the requested payment within the time period (124).

The transaction management component 212 directs fulfillment of each of the plurality of orders, responsive to the determination (126). In one embodiment, the transaction management component 212 instructs the retailer transaction management component 214 to fulfill each of the plurality of orders. In another embodiment, the transaction management component 212 instructs the retailer transaction management component 214 executing on the first computing device 106a to fulfill at least one of the plurality of orders and instructs a second retailer transaction management component 214 executing on a fourth computing device 106c to fulfill at least one of the plurality of orders.

Referring now to FIG. 1D, a flow diagram depicts one embodiment of a method for reserving and completing purchases. In brief overview, the method includes receiving, by a transaction management component executing on a first computing device, a plurality of payment authorization codes from a user of a second computing device, each of the plurality of payment authorization codes associated with one of a plurality of orders placed by the user (130). The method includes requesting, by the transaction management component, from the user, a payment for each of the plurality of orders within a time period (132). The method includes determining, by the transaction management component, that the user provided a subset of the requested payment within the time period (134). The method includes identifying, by the transaction management component, one of the plurality of orders that the subset of the requested payment is sufficient to complete (136). The method includes instructing, by the transaction management component, a retailer transaction management component associated with the identified one of the plurality of orders to fulfill the identified one of the plurality of orders, responsive to the identification (138).

Referring still to FIG. 1D, and in conjunction with FIG. 1A, the transaction management component 212 receives a plurality of payment authorization codes from a user of a second computing device, each of the plurality of payment authorization codes associated with one of a plurality of orders placed by the user (130). The transaction management component 212 requests, from the user, a payment for each of the plurality of orders within a time period (132). The transaction management component 212 determines that the user provided a subset of the requested payment within the time period (134).

The transaction management component 212 identifies one of the plurality of orders that the subset of the requested payment is sufficient to complete (136). In some embodiments, a plurality of reserved shopping baskets is paid for with one transaction if the payor's virtual “wallet” has been replenished to at least the value of the accumulated reserved shopping baskets. In one embodiment, the transaction management component 212 applies an algorithm to identify the one of the plurality of orders that the subset of the requested payment is sufficient to complete. In such an embodiment, the transaction management component 212 resolves the accumulated reservations on at least one of a first-in-first-out basis and a “best fit” basis to identify items that are possible to fulfill in relation to the amount to which the virtual account has been replenished. The transaction management component 212 instructs a retailer transaction management component associated with the identified one of the plurality of orders to fulfill the identified one of the plurality of orders, responsive to the identification (138).

In another embodiment, the transaction management component 212 identifies a second one of the plurality of orders that the subset of the requested payment is sufficient to complete. In this embodiment, the transaction management component 212 instructs the retailer transaction management component 214 associated with the identified second one of the plurality of orders to fulfill the identified second order responsive to the identification.

In other embodiments, the transaction management component 212 determines that the subset of the requested payment is insufficient to complete a second one of the plurality of orders. In such an embodiment, the transaction management component 212 may request, from the user, an additional payment for each unfulfilled order in the plurality of orders within a second time period.

Referring now to FIG. 1E, a flow diagram depicts one embodiment of a method of reserving and completing purchases. In brief overview, the method includes receiving, by an account management component executing on a first computer, funding from a user for deposit into a user account (140). The method includes transmitting, by a second computing device, a payment authorization code to a third computing device, the payment authorization code associated with a first order placed by the user (142). The method includes receiving, by a transaction management component executing on the first computing device, the payment authorization code from the third computing device (144). The method includes determining, by the transaction management component, that the funding in the user account is sufficient to pay for the first order (146). The method includes instructing, by the transaction management component, a retailer transaction management component executing on the second computing device to fulfill the first order, responsive to the determination (148). The method includes providing, by a fourth computing device, to the third computing device, a second payment authorization code associated with a second order placed by the user (150). The method includes transmitting, by the third computing device, to the transaction management component, the second payment authorization code (152). The method includes determining, by the transaction management component, that the funding in the user account is insufficient to pay for the second order (154). The method includes requesting, by the transaction management component, from the user, additional funds to complete the second order within a time period (156). The method includes determining, by the transaction management component, that the user provided the requested additional funds within the time period (158). The method includes instructing, by the transaction management component, a second retailer transaction management component executing on the fourth computing device to fulfill the second order, responsive to the determination (160). In one embodiment, a single retailer operates the second computing device and the fourth computing device. In another embodiment, a first retailer operates the second computing device and a second retailer operates the fourth computing device.

Referring still to FIG. 1E, the method includes receiving, by an account management component executing on a first computer, funding from a user for deposit into a user account. In one embodiment, a user of a client 102 accesses a third computing device 106b and establishes a user account for authorizing transaction payments. In another embodiment, the second computing device 102 displays, to the user, a user interface received from the third computing device 106b (e.g., a web page including a user interface displayed by a web browser executing on the second computing device 102). In still another embodiment, the user transfers a certain amount of money to the account (for example, for a pre-paid account). In still another embodiment, the user agrees to provide a payment to the authorization system operating the third computing device 106b when a balance of money associated with the account is less than a predetermined amount. In another embodiment, a mobile number identifies the account. In yet another embodiment, a user account is referred to as a “wallet”. In some embodiments, when a user authorizes a payment for a transaction, the third computing device 106b directs the transfer of money from the user account (the “wallet”) to a retailer (e.g., a retailer operating the first computing device 106a). In one of these embodiments, if a wallet contains insufficient funds to pay the retailer for the transaction, the user is given an opportunity to transfer additional funds to the wallet. For example, the user may “top up” the wallet (e.g., pay via cash or credit to transfer additional funding to the account).

In some embodiments, the ability to top up an account within a specified period of time results in a system that provides functionality for making deferred payments while automatically reserving a user transaction for the specified period of time. In one of these embodiments, the methods and systems described herein provide increased flexibility for consumers by allowing users the option of either paying at the time of the transaction or at a later point in time.

Although described herein in the context of an online shopping experience, it should be understood that the methods and systems described herein apply to any remote payment opportunities in which a consumer and one or more retailers are remotely located from each other; for example, in a mail-order shopping environment, or a television shopping environment.

Referring now to FIG. 2, a block diagram depicts one embodiment of a system for providing consumers with codes for authorizing payment completion via mobile phone communications. In brief overview, the system includes a first server 106a, a second server 106b, and a client 102. The second server 106b includes a user interface 202, a code request component 204, and a retailer transaction management component 214. The first server 106a includes a code generation component 206, a code block allocator 207, a payment code manager 209, a code processing component 208, an account updating component 210, and a transaction management component 212.

Referring still to FIG. 2, and in one embodiment, the second server 106b generates a user interface 202 for display to the client 102. In another embodiment, by way of example, the client 102 retrieves a web page containing the user interface 202 from the second server 106b. In yet another embodiment, a user of the client 102 initiates a transaction for the purchase of goods or services via the user interface 202.

In one embodiment, the second server 106b executes a code request component 204. In another embodiment, the code request component 204 receives, from a user of the client 102, via the user interface 202, a request to pay for goods or services. In still another embodiment, the code request component 204 requests, from the code generation component 206 executing on the first server 106a, generation of a payment authorization code. In some embodiments, a code block allocator 207 creates new codes and a payment code manager 209 retrieves codes and issues them to retailers. In still even another embodiment, the second server 106b transmits, to the client 102, the generated payment authorization code. In yet another embodiment, the first server 106a transmits, to the client 102, the generated payment authorization code.

In some embodiments, the user transmits the payment authorization code via a text message, MMS message, SMS message or other messaging service. In other embodiments, the user transmits the payment authorization code using any communication means, including, by way of example, across a network 104.

In one embodiment, when a code is claimed, the first server 106a executes software, such as a transaction management component 212, to create a retail transaction. In another embodiment, for checkout codes, the transaction management component 212 creates a checkout transaction; for product codes, a product code transaction is created. In some embodiments, the terms “checkout code” and “checkout transaction” may be used interchangeably. In still another embodiment, if a code is not claimed, the first server 106a may cancel the transaction; alternatively, the first server 106a may invalidate the code if it is not claimed. If an unclaimed code is cancelled, the first server 106a may transmit an indication to the retailer that the status of the code has changed. In some embodiments, the transaction management component 212 includes a code manager module (not shown) defining at least one event bus listener; such an event handler may execute a claimed transaction resolver (not shown) that queries a database for pending transactions associated with a wallet that has funds credited to it and that identifies transaction for resolution. In other embodiments, the transaction management component 212 (and relevant sub-components, such as the claimed transaction resolver or the code manager module) executes when a balance-increasing action occurs for a user wallet.

In some embodiments, a transaction management component 212 includes functionality for maintaining a current state of a transaction for which a payment authorization code was generated. In one of these embodiments, by way of example and without limitation, transactions can be in any of the following states:

| State | Status | Description |
|---|---|---|
| PENDING | Interim | Checkout codes only. The checkout code has |
| | | been issued but not yet claimed by the |
| | | purchaser. The retailer's order remains |
| | | reserved. |
| CLAIMED | Interim | The code has been claimed by the purchaser |
| | | but they did not have sufficient funds to |
| | | pay for it. The retailer's order remains |
| | | reserved. |
| PAID | Interim | The transaction is paid for. The funds have |
| | | been deducted from the user's wallet. The |
| | | first server 106a is waiting on the retailer |
| | | to acknowledge that they have shipped the |
| | | transaction. |
| SHIPPED | Final | The retailer has shipped the goods and has |
| | | confirmed to the first serve 106a that they |
| | | have shipped the goods. |
| FAILED | Final | Transaction has failed. Retailer order |
| | | should be cancelled. |

In another of these embodiments, a transaction having a status of “final” does not undergo further state transitions and is considered “closed”. In still another embodiment, the status of retail transactions that have a status of “interim” may undergo further state transitions.

In some embodiments, a transaction having an “interim” status may be associated with an indicator of a time of expiration and, if the status has not changed at the time of expiration, the transaction may be transitioned to a failed state. In other embodiments, each retail transaction has two timers associated with it: the expiry time and the “will ship by” time. In one of these embodiments, when a retail transaction is created in the platform, a purchaser has until the expiry time to pay for that transaction; if a retail transaction is still in the PENDING or CLAIMED states when the expiry time passes, the first server 106a will fail the transaction. In another of these embodiments, once a retail transaction reaches the PAID state, the retailer has until the “will ship by” time to acknowledge to the first server 106a that they have shipped the goods (or completed the services) associated with that retail transaction. In still another of these embodiments, by way of example, this may be accomplished when the second server 106b transmits an indication of completion to the first server 106a, for example via a command issued according to an application programming interface (e.g., a shippingConfirmation API). In yet another of these embodiments, if a transaction is still in the PAID state when this time passes, the first server 106a will fail the transaction and process a refund to the purchaser.

In one embodiment, for example, the notion of goods shipping is not relevant to a particular retailer, or to a specific transaction for a retailer. In such an embodiment, a transaction can be marked as not requiring shipping. If a transaction does not require shipping, then once the notifyCodeStatus callback for the PAID state is successful to the retailer, the system can update the transaction's status to SHIPPED. The “shipping required” property of a retailer's transactions can be configured to default to one or the other, or can be explicitly controlled via a command issued according to an application programming interface (e.g., a generateCode API call). In other embodiments, retailers that are using transaction polling instead of callbacks will provide confirmation of shipping; polling and callbacks are discussed in additional detail below.

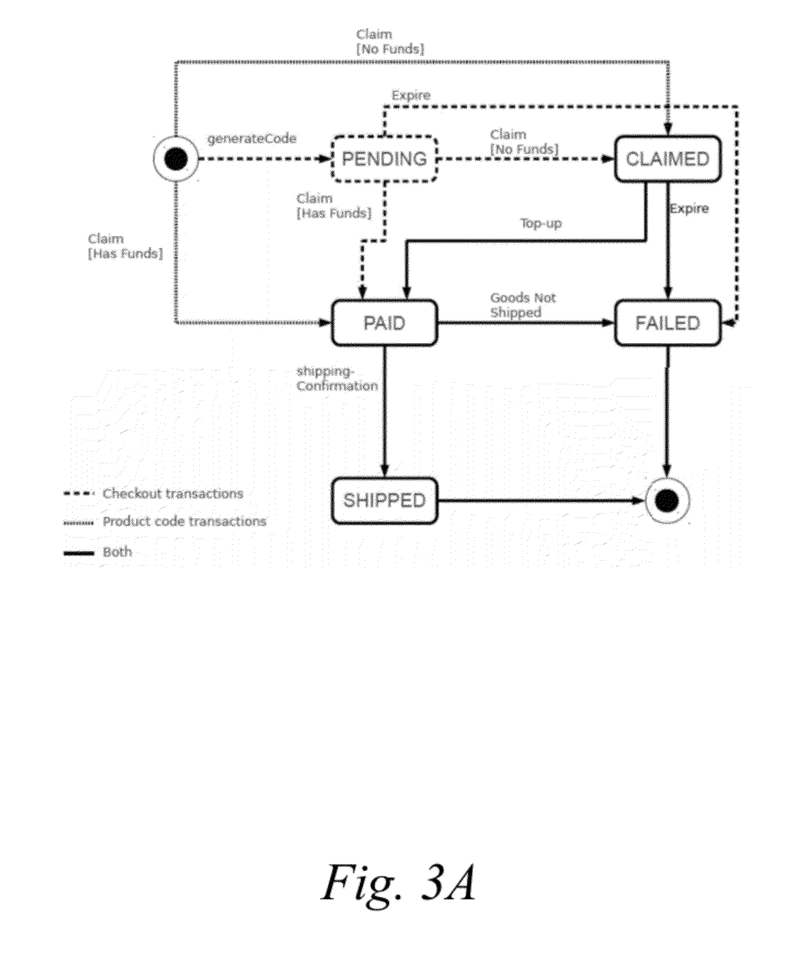

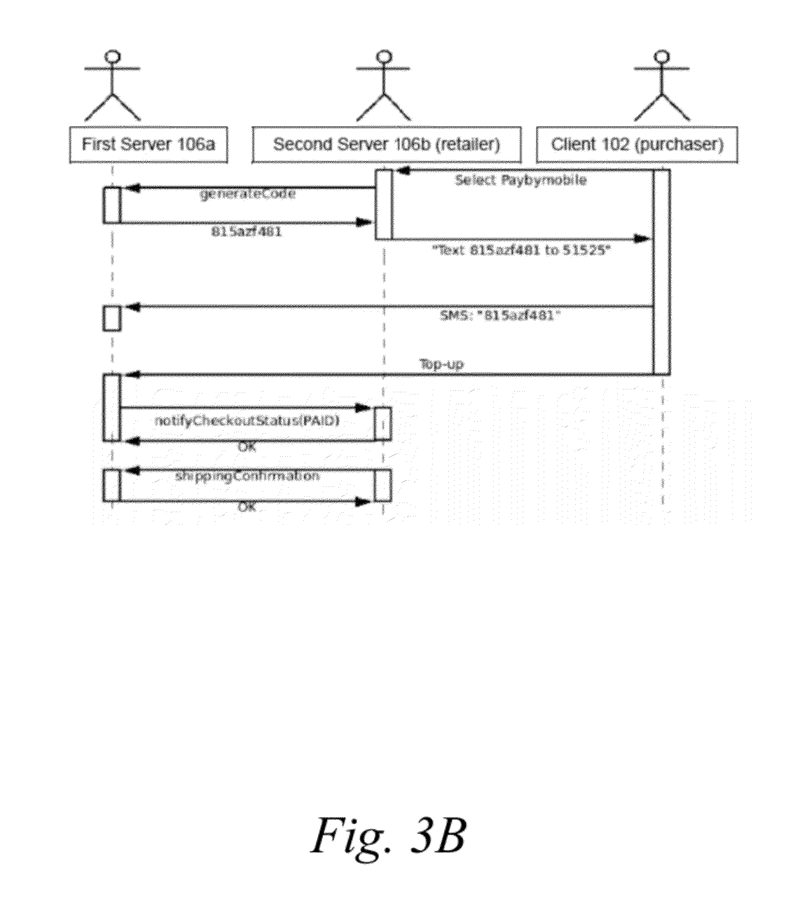

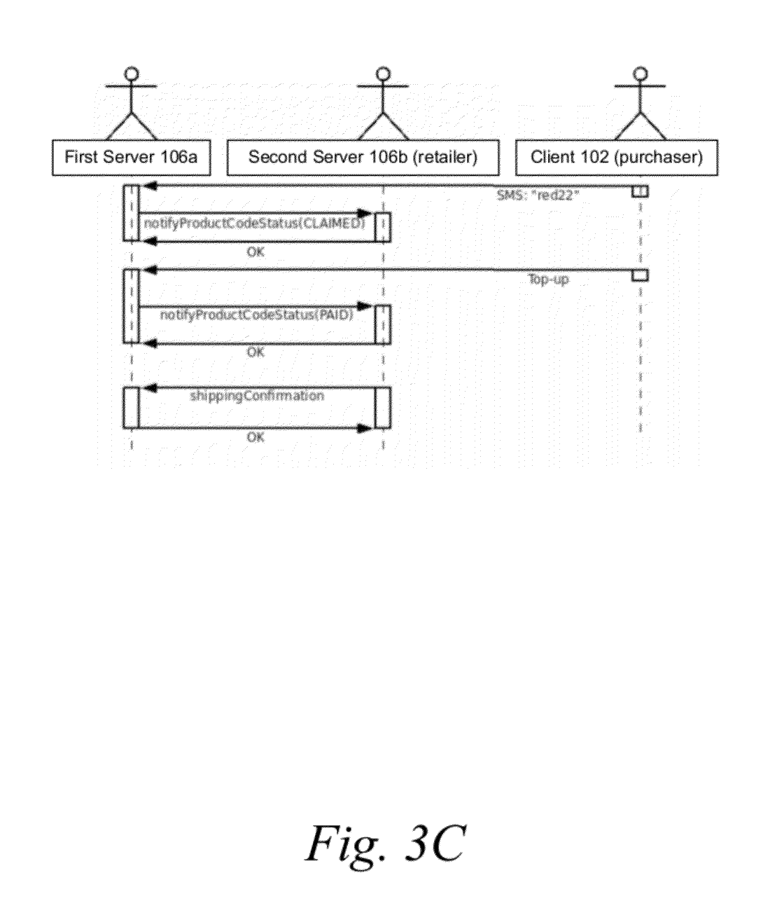

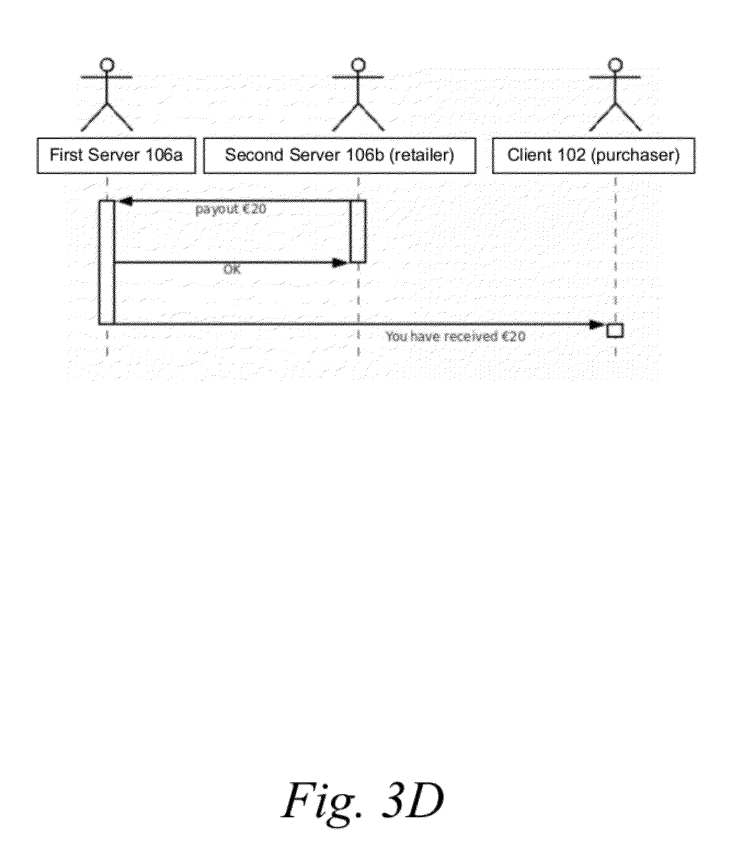

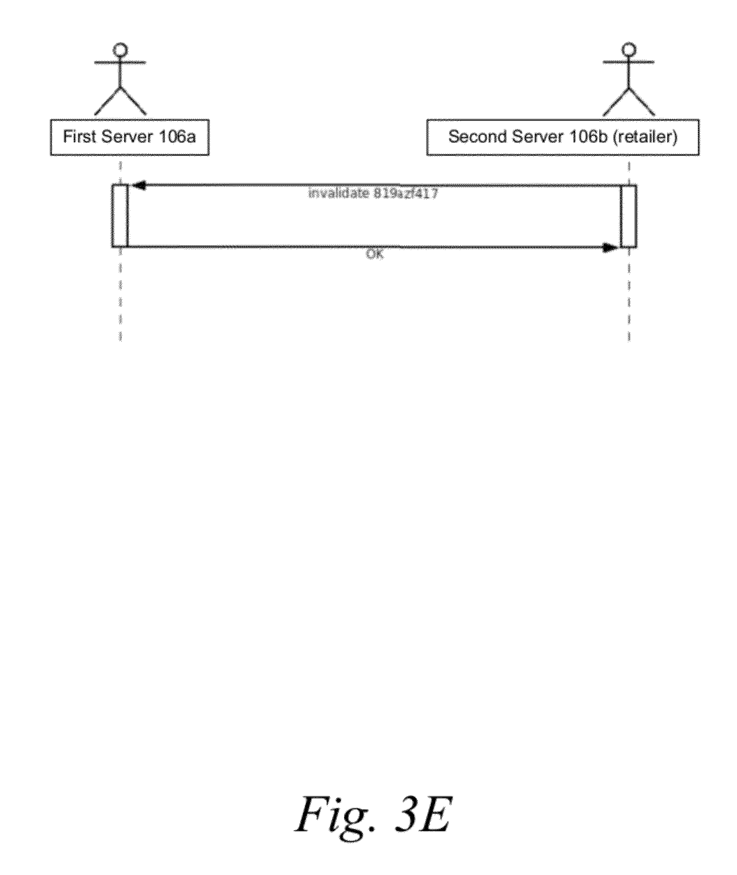

Referring now to FIG. 3A, and in connection with FIG. 2, a flow diagram depicts one embodiment of a state life cycle for a transaction. In one embodiment, for a checkout transaction (in which a payment authorization code is, for example, a single-use code, unique to the particular transaction), the code is generated and transmitted to the client 102; the state of the transaction at that time is “pending”. If the user of the client 102 transmits to the first server 106a approval to proceed with the transaction but the user has insufficient funds to complete the transaction, the state of the transaction is changed to “claimed” and the user is provided with a specified period of time in which to provide additional funding to the user account from which the funds would be withdrawn and transferred to the retailer. In some embodiments, the flexibility to allow a user to either pay at the time of a transaction or to reserve the transaction and pay later provides consumers with increased flexibility. If the user of the client 102 has sufficient funds to complete the transaction and transmits to the first server 106a approval to proceed with the transaction, the status of the transaction is changed to “paid”. In some embodiments, a retailer is notified of changes to the status of the transaction. If the retailer provides shipping confirmation within a specified period of time, the state of the transaction is changed to “shipped” and the transaction is closed. If the retailer fails to provide shipping confirmation within the specified period of time, or if the user fails to provide additional funding to the account within the specified period of time, or if the user does not transmit the code to the first server 106a within a specified period of time, the state of the transaction is changed to “failed”. In some embodiments, when a retail transaction reaches the FAILED state, the reason for its failure will also be recorded. In one of these embodiments, the failure reasons may include, without limitation, any of the following:

| Failure | |
|---|---|
| Code | Description |
| OK | No failure |
| MAX_LIMIT | Exceeds maximum transaction limit |
| EXPIRED | Code was never claimed and has expired. |
| NO_FUNDS | Insufficient funds. The purchaser did not top-up within the |
| | allotted reservation window. |
| CANCELLED_FRAUD | Cancelled due to suspected fraud. |
| CANCELLED_RETAILER | Cancelled by retailer. |
| CANCELLED_USER | Cancelled by the user. |
| ADULT_CONTENT | Adult content conflict. User is under age and cannot |
| | purchase |
| GOODS_NOT_SHIPPED | The retailer failed to ship the goods before the will-ship-by |
| | deadline. |

In other embodiments depicted by FIG. 2A, a product code transaction occurs. In one embodiment, a code is generated. If the user of the client 102 transmits to the first server 106a approval to proceed with the transaction but the user has insufficient funds to complete the transaction, the state of the transaction is changed to “claimed” and the user is provided with a specified period of time in which to provide additional funding to the user account from which the funds would be withdrawn and transferred to the retailer. If the user of the client 102 has sufficient funds to complete the transaction and transmits to the first server 106a approval to proceed with the transaction, the status of the transaction is changed to “paid”. If the retailer provides shipping confirmation within a specified period of time, the state of the transaction is changed to “shipped” and the transaction is closed. If the retailer fails to provide shipping confirmation within the specified period of time, or if the user fails to provide additional funding to the account within the specified period of time, or if the user does not transmit the code to the first server 106a within a specified period of time, the state of the transaction is changed to “failed”. In some embodiments, when a retail transaction reaches the FAILED state, the reason for its failure will also be recorded.

In some embodiments, the second server 106b executes a retailer transaction management component 214 that provides functionality for allowing a retailer to determine the current state of a retail transaction—which may be used in order to know whether or not a purchaser has paid yet—as well as whether or not the retailer should deliver the goods or services. In some embodiments, the system provides two approaches for providing this functionality: callbacks and polling. In one of these embodiments, using callbacks, the first server 106a notifies the second server 106b of updates to a retail transaction in real-time. In another of these embodiments, if a retailer is unable to support callbacks, they will need to use a polling strategy in order to discover the state of their outstanding retail transactions.

In one embodiment, when using batch settlement, the second server 106b periodically makes API calls to the first server 106a (e.g., via a getCodeStatus API or a getCodeStatusByTime API). In another embodiment, by way of example, the second server 106b can call the getCodeStatus API, passing in all of its PENDING or CLAIMED checkout codes; a component executing on the first server 106a will receive the getCodeStatus request and respond with each of the codes' current states. In still another embodiment, and as an additional example, the second server 106b can call the getCodeStatusByTime API, passing in a timestamp (e.g., that of the last time it called this API); a component executing on the first server 106a will receive the getCodeStatusByTime request and respond with the code states of all codes which transitioned from the PENDING or CLAIMED states since the given timestamp. In some embodiments, administrators of the first server 106a and of the second server 106b agree to a polling schedule.

In other embodiments, the system includes functionality referred to as “prompted batch settlement”. In one of these embodiments, a retailer can set up an email address in their own system that is automatically monitored. In another of these embodiments, when a checkout code is updated (or, in another example, either a count or time threshold has been reached within the first server 106a), an email will be generated and sent to the configured retailer email account. In another of these embodiments, when the retailer receives an email to this account, the retailer can direct the second server 106b to poll the first server 106a for checkout code updates. In still another of these embodiments, this outbound email is therefore a “prompt” to the retailer that now is a good time to poll for checkout code updates.

In some embodiments, the first server 106a can pro-actively inform a retailer's system (e.g., second server 106b) about certain events that occur within the platform. In one of these embodiments, “callbacks” are used to inform the retailer of state changes in retail transactions. In another of these embodiments, there are also callbacks that inform the retailer of important subscription-related events. In still another of these embodiments, to receive callback services, the retailer exposes a machine-accessible endpoint on their system which allows the first server 106a to notify them of events that have occurred. In still even another of these embodiments, callbacks are implemented as calls to web services. In yet another of these embodiments, basic GET as well as “x-www-form-urlencoded” POST requests are supported and other technologies can be plugged in.

In one embodiment, a callback end-point (e.g., a second server 106b) returns a response to the first server 106a; this allows the platform to confirm that the retailer's system has understood the request that was sent to it. In another embodiment, if a callback fails, retries may be attempted depending on the response code returned by the remote end-point. In still another embodiment, should the first server 106a decide that retries are necessary, the schedule such as the following may be implemented:
1. Callbacks will be retried every 5 minutes for the next 25 minutes following the first failed call.
2. If the first 5 retries fail, the first server 106a will notify the retailer administrator of a “temporary failure” situation via email.
3. The first server 106a will then try once per hour for the following 5 hours.
4. If all retries fail, the callback will be considered permanently failed and an error notification will be sent to both the retailer and to the first server 106a via email so that manual intervention can occur.

In one embodiment, callback end-points may return either text or an integer value. The values they may return include, without limitation, those described the following table:

| Response | Integer Value | Description |
|---|---|---|
| OK | 0 | The callback was successful. |
| CLIENT ERROR | 1 | The system has attempted an invalid callback. |
| | | Either a bad URL has been passed, or one of the |
| | | values passed in the callback was invalid. If a |
| | | callback end-point returns this response then it is |
| | | considered permanent. Retries will NOT be |
| | | attempted. |
| TRY AGAIN | 2 | This is an explicit request by the retailer's system |
| | | for the system to try the callback again at a later |
| | | time. This can be useful if the retailer's system is |
| | | undergoing scheduled maintenance. |
| SERVER ERROR | 3 | An error has occurred in the callback-endpoint |
| | | server while processing the callback. Retries will be |
| | | attempted by the system. |

These response codes may be common across all of the callback endpoints. Further response codes specific to each endpoint may be defined.

In one embodiment, the callback framework can support arbitrary responses from remote HTTP endpoints by mapping them back to its own responses, for situations where a retailer already has an existing end-point that is suitable for re-use as a callback end-point. For example, if an existing retailer end-point returns “SUCCESS” when a given request succeeds, “BAD PARAMETER” when a request passes an invalid value and “INTERNAL ERROR” for other exceptional situations, these retailer-specific responses can be translated into the responses that the first server 106a can process. “SUCCESS” would be mapped directly to “OK”, “BAD PARAMETER” to “CLIENT ERROR” and “INTERNAL ERROR” to “SERVER ERROR”. Responses do not have to have a one-to-one mapping; multiple retailer responses might all map to “OK” for example.

In one embodiment, an end-point will be called by the first server 106a when a checkout transaction's state has been modified (such an end-point may have requested a notification of checkout status). In another embodiment, the retailer will receive a callback whenever the checkout transaction changes state except when the transaction becomes:
PENDING: This state is entered as a result of the generateCode API request from the retailer. As such, there is no need to inform the retailer that this state has been reached.
SHIPPED: This state is entered as a result of the shippingConfirmation API request from the retailer so a callback is unnecessary. SHIPPED may also be reached automatically when shipping is not required and the notifyCodeStatus callback for the PAID state is successful. Again, in this situation there is no need to inform the retailer.
   In another embodiment, some or all of the following parameters may be supplied to the retailer in the callback:

| Name | Type | Description |
|---|---|---|
| pbmUtr | String | A transaction reference. This will be the |
| | | same UTR as returned in the response to |
| | | generateCode. |
| retailerUtr | String | The retailer's unique transaction reference, |
| | | as captured during the generateCode API |
| | | endpoint. |
| code | String | The checkout code that is associated with |
| | | the transaction. |
| state | String | The new state of the checkout transaction. |
| timestamp | Timestamp | The date and time that the checkout |
| | | transaction entered the new state. |
| failedCode | Integer | If state is FAILED, this field will be |
| | | present providing the reason why the |
| | | transaction has failed. |
| callbackData | String | The callback data that the retailer supplied |
| | | in the generateCode request. |

In another embodiment, the following is an example of a callback posting:

POST /callbacks /notifyCodeStatus HTTP/1.1 Host:
callback.retailer.com
Content-Type: application/x-www-form-urlencoded
Content-Length: 95
pbmUtr=12998475-abfe-ffd9-a78299af
&retailerUtr=123456789
&code=821adg213
&state=FAILED
&timestamp=2008-10-
13T10%3A22%3A00%2B01%3A00 &failedCode=02
&callbackData=83498349845738

In one embodiment, an end-point will be called by the first server 106a when a product code transaction's state has been modified. In this embodiment, the retailer will receive a callback whenever the product code transaction changes state except, except when it is updated to SHIPPED (for the same reasons as provided above). In another embodiment, some or all of the following parameters may be supplied to the retailer in the callback:

| Name | Type | Description |
|---|---|---|
| pbmUtr | String | The UTR of the transaction that was |
| | | created in deducting the subscription |
| | | amount from the customer's wallet. |
| Code | String | The product code that is associated |
| | | with the transaction. |
| Msisdn | String | The mobile number of the customer. |
| Emait | String | The email address of the customer. |
| Timestamp | Timestamp | The date and time that the product |
| | | code transaction entered the new state. |
| State | String | The new state of the product code |
| | | transaction. |

In still another embodiment, the following is an example of a callback posting:

POST /callbacks /productCodePaid HTTP/1.1 Host:
callback.retailer.com
Content-Type: application/x-www-form-urlencoded
Content-Length: 95
pbmUtr=a0997a97-0ed2-4e9e-b6cf-3c7c2ef77297
&code=movies100
&msisdn=353858118293
&email=joe.bloggs@someplace.com
&timestamp=2008-10-
13T10%3A22%3A00%2B00%3A00 &stat=PAID

In one embodiment, an end-point will be called by the first server 106a when the state of a subscription has changed. A subscription's state may be modified by a number of factors, including:
A subscription expiring due to not being activated.
A customer clicking the activation link to activate a subscription.
A customer cancelling a subscription.
A retailer cancelling a subscription.
The subscription reaching its COMPLETE state.

In another embodiment, some or all of the following parameters may be supplied to the retailer in the callback:

| Name | Type | Description |
|---|---|---|
| subscriptionRef | String | The unique reference that identifies |
| | | the subscription. |
| State | String | The new state of the subscription. |
| Amount | Amount | The recurring amount that this sub- |
| | | scription is set up to charge. |
| Next | Date | The date the next charge will be made |
| | | to the user (may not be present if |
| | | the subscription is not LIVE). |
| remainingPayments | Integer | The number of payments remaining (may |
| | | not be present if this subscription |
| | | does not have a maximum number of |
| | | payments). |

In still another embodiment, the following is an example of a callback posting:

POST /callbacks/ subscriptionState HTTP/1.1 Host:
callback.retailer.com
Content-Type: application/x-www-form-urlencoded
Content-Length: 95
subscriptionRef=4723875-187f384-2893454
&state=COMPLETE
&remainingPayments=0

In one embodiment, an end-point will be called by the first server 106a when a customer has been successfully charged for a subscription. If a retailer receives this callback, then the subscription amount has been successfully deducted from a customer's wallet. In another embodiment, some or all of the following parameters may be supplied to the retailer in the callback:

| Name | Type | Description |
|---|---|---|
| subscriptionRef | String | The unique reference that identifies |
| | | the subscription. |
| State | String | The current state of the subscription, |
| | | which should always be LIVE for the |
| | | subscriptionPaid endpoint. |
| pbmUtr | String | The UTR of the transaction that was |
| | | created in deducting the subscription |
| | | amount from the customer's wallet. |
| Amount | Amount | The amount that was deducted from the |
| | | customer's wallet. |
| Next | Date | The date the next charge will be made |
| | | to the user (may not be present if the |
| | | subscription is COMPLETE). |
| remainingPayments | Integer | The number of payments remaining (may |
| | | not be present if this subscription |
| | | does not have a maximum number of |
| | | payments). |

In still another embodiment, the following is an example of a callback posting:

POST /callbacks/subcriptionPaid HTTP/1.1 Host:
callback.retailer.com
Content-Type: application/x-www-form-urlencoded
Content-Length: 95
subscriptionRef=4723875-187f384-2893454
&state=LIVE
&pbmUtr=12998475-abfe-ffd9-a78299af
&amount=EUR3.00
&next=2011-04-08
&remainingPayments=32

In still another embodiment, the following is another example of a callback:

```
<?xml version=“1.0” encoding=“UTF-8”?>
<subscriptionPaidRequest xmlns=“http: //www.demo.net/api/retail”>
  <subscriptionRef>4723875-187f384-2893454</subscriptionRef>
  <state>LIVE</state>
  <pbmUtr>12998475-abfe-ffd9-a78299af</pbmUtr>
  <amount>EUR3.00</amount>
  <next>2011-04-08</next>
  <remainingPayments>32</remainingPayments>
  </subscriptionPaidRequest>
```

In one embodiment, an end-point will be called by the first server 106a when a customer has missed a payment in their subscription. In another embodiment, this may happen when the billing date arrives but the user does not have sufficient funds in their wallet to cover the subscription charge. In still another embodiment, the system does not carry out any action when a subscription payment is missed other than informing the retailer.

In one embodiment, some or all of the following parameters may be supplied to the retailer in the callback:

| Name | Type | Description |
|---|---|---|
| subscriptionRef | String | The unique reference that identifies |
| | | the subscription. |
| state | String | The current state of the subscription, |
| | | which should be LIVE for the |
| | | subscriptionMissed endpoint. |
| amount | Amount | The recurring amount that this sub- |
| | | scription is set up to charge. |
| next | Date | The date the next charge will be made |
| | | to the user (may not be present if the |
| | | subscription is COMPLETE). |
| remainingPayments | Integer | The number of payments remaining (may |
| | | not be present if this subscription |
| | | does not have a maximum number of |
| | | payments). |

In still another embodiment, the following is an example of a callback posting:

```
POST /callbacks/ subscriptionMissed HTTP/1.1 Host:
callback.retailer.com
Content-Type: application/x-www-form-urlencoded
Content-Length: 95
subscriptionRef=4723875-187f384-2893454
&state=LIVE
&amount=EUR3.00
&next=2011-04-15
<?xml version=“1.0” encoding=“UTF-8”?>
<subscriptionMissedRequest xmlns=“http: //www.example.net/api/retail”>
  <subscriptionRef>4723875-187f384-2893454</subscriptionRef>
  <state>LIVE</state>
  <amount>EUR3.00</amount>
  <next>2011-04-15</next>
  <remainingPayments>31</remainingPayments>
</subscriptionMissedRequest>
```

In one embodiment, the system includes functionality for supporting recurring payments without requiring further intervention from a customer after the initial setup, other than keeping their wallet topped up. In another embodiment, subscriptions are set up in the platform using a form of the generateCode request. In still another embodiment, once a subscription is set up, it will run indefinitely until either the retailer or the customer cancels it, or a fixed-term subscription completes. In still even another embodiment, when a retailer sets up a new subscription, they supply a unique “subscription reference” that can be used to identify the subscription. In yet another embodiment, the subscription reference can be thought of as similar to a unique transaction reference (UTR) for a transaction. In some embodiments, subscription states may include, without limitation, the following:

| State | Description |
|---|---|
| PENDING | A subscription has been set up (via a checkout |
| | code request) but the customer has not yet |
| | confirmed the subscription. |
| LIVE | The subscription has been set up and confirmed |
| | by the customer. |
| SUSPENDED | The subscription has been suspended. It will |
| | still be updated but no charges will be made to |
| | the customer's wallet. |
| CANCELLED | The subscription has been cancelled. |
| COMPLETE | The subscription had a limited run (for example, |
| | 12 monthly charges) and has completed that |
| | limited run. |
| EXPIRED | The subscription has expired. Subscriptions expire |
| | when the checkout code they are attached to |
| | expires. This usually happens when a customer |
| | fails to “claim” the checkout code by |
| | texting it in to the system. |

When a subscription is first created in the system via a generateCode request, it will be initialized in the PENDING state. Such a subscription will be unattached to any user account (which may be referred to as “a wallet”). When a customer claims the checkout code that the subscription is associated with, the subscription is also associated with that customer's wallet. The subscription state, however, remains as PENDING. The customer is sent an e-mail informing them that they now have a subscription associated with their wallet. The customer can activate the subscription by following a URL provided within the e-mail. When the customer has clicked this URL to accept the subscription will the subscription's state be updated to the LIVE state. If the checkout code with which a subscription is associated expires, either because it is never claimed or because a customer claims it but does not provide funding in time to pay for the subscription (a process which may be referred to as “topping up”), then the subscription state will also be updated to EXPIRED. EXPIRED subscriptions are not charged for and do not typically transition to another state. Once a subscription is in the LIVE state, it may be charged for according to the recurring amount and period as set up by the retailer. During the lifetime of a LIVE subscription, the user can receive a reminder e-mail (e.g., approximately 48 hours before their next charge date in each billing period). This e-mail will remind them to keep in their “wallet” a balance with sufficient funds to cover the subscription. It will also provide a URL that will allow the customer to cancel the subscription; if the customer clicks this link, the subscription's state will be updated to CANCELLED and no further charges will be made for it.

The SUSPENDED state for subscriptions is a state that is like LIVE in terms of routine processing (reminder emails can be sent and billing periods can be updated) but no charges will be made for a subscription while it is in this state. The SUSPENDED state is intended for use by retailers that allow a customer to take a “break” from their subscription (e.g., suspending a newspaper subscription while on vacation). At any point, the subscription may be returned to the LIVE state, causing it to be charged for again.

A COMPLETE subscription is one which has reached the end of a fixed-term run. While some subscriptions may be indefinite in how many payments are taken (until such time as they are cancelled by either the customer or the retailer), others can stipulate a fixed number of payments that are to be made. For example, for a one-year subscription to be charged monthly, a subscription may be set up with a billing period of “monthly” and a total number of payments of 12. After the twelfth payment, the subscription's state will be updated to COMPLETE and no further charges will be made.

In some embodiments, billing periods may include, without limitation, the following:

| Value | Description |
|---|---|
| WEEKLY | Charged once per week, on the same day of every |
| | week. For example, every Monday. |
| BIWEEKLY | Charged once every two weeks, on the same day of |
| | the week each period. For example, every second |
| | Wednesday. |
| MONTHLY | Charged once per month, on the same date every |
| | month. For example, the 1st of the month. |
| QUARTERLY | Charged once every three months, on the same date |
| | every third month. For example, the 23^{rd} of the |
| | month. |
| ANNUALLY | Charged once per year, on the same date every |
| | year. For example, October 31st. |

Referring now to FIG. 3B, and in connection with FIG. 2, a flow diagram depicts one embodiment of a method for paying for goods or services at a retailer website using the methods and systems described herein. In one embodiment, a purchaser (end-user) is provided with a checkout code. The checkout code is requested by a retailer (by directing the second server 106b to request generation of the code from the first server 106a) and associated with a particular retailer order. The purchaser then claims the code by transmitting the code—for example, via a text message—to the first server 106a, and then pays for the transaction by topping up their user account with the first server 106a (the “wallet”). In some embodiments, the checkout flow follows these steps: i) The purchaser indicates that they wish to pay for a transaction via their mobile device (or other client 102), ii) the retailer requests a new checkout code using by communicating with the first server 106a, iii) the first server 106a issues a new “pending” checkout code to the retailer, along with a unique transaction ID which can be used to identify the transaction, iv) the retailer displays the checkout code to the purchaser, informing them they transmit (e.g., via a text message) the checkout code to the first server 106a to complete the transaction, v) the user texts the checkout code in to the first server 106a, vi) the first server 106a changes the pending state to a “claimed” state. If the user has sufficient funds in their wallet to complete the transaction, the first server 106a will deduct the funds and inform the retailer than that checkout code has been transitioned to the “paid” state. Otherwise, the user has a given amount of time (e.g., 24 hours) to top-up their wallet. If the user does this within the valid period, the retailer will get the same callback informing them that the checkout code is now “paid”. The retailer then informs the first server that the goods have shipped via, for example, a shippingConfirmation API.

Referring now to FIG. 3C, and in connection with FIG. 2, a flow diagram depicts one embodiment of a method for paying via mobile phone for a good or service using a product code. In one embodiment, retailers can set up product codes with the first server 106a. A product code can be claimed by multiple purchasers by texting that code to the first server 106a. The following is an example of embodiment of the steps taken in a method for paying via mobile phone for a good or service using a product code:
a. User texts product code “red22” to the first server 106a.
b. The first server 106a creates a product code transaction in the CLAIMED state for the purchaser.
c. The first server 106a informs the retailer of a new product code transaction in the CLAIMED state.
d. Purchaser tops up their wallet.
e. The first server 106a informs the retailer that the product code transaction is PAID.
f. Retailer processes the order.
g. Retailer informs the first server 106a that they have SHIPPED the order.

Referring now to FIG. 3D, and in connection with FIG. 2, a flow diagram depicts one embodiment of a method for refunding a purchaser's authorized payment. In one embodiment, if a retailer wishes to credit funds to a customer's wallet, they use a “payout” method, which may include sending a command to the first server 106a via an API. In another embodiment, the retailer transmits, from the second server 106b, to the first server 106a, a command to initiate the pay-out; the retailer may also transmit a mobile number of the account to be credited along with the currency amount. The first server 106a credits the specified amount to the recipient's wallet. The first server 106a responds to the retailer with a unique transaction ID, identifying the payout transaction. The first server 106a informs the customer that they have received funds from the retailer.

Referring now to FIG. 3E, and in connection with FIG. 2, a flow diagram depicts one embodiment of a method for invalidating a checkout transaction. In one embodiment, a checkout transaction may be invalidated (cancelled) by the retailer. This situation may occur, for example, if the purchaser cancels their order with the retailer after they have placed it. In another embodiment, a retailer has already requested a checkout code from first server 106a and displayed it to the user. In another embodiment, a user decides to cancel an order placed with the retailer. In still another embodiment, the retailer transmits, from the second server 106b, to the first server 106b, a command according to an API (e.g., a call to an invalidateCode API) to cancel the pending checkout code with first server 106a.

In some embodiments, transactions, retailer and payment service provider systems are identified by a unique transaction reference, or UTR. UTRs may be globally-unique identifiers that are used to uniquely identify individual transactions in each system. In one of these embodiments, API calls may have the retailer to pass in a UTR. This retailer UTR may be stored in a database along with a UTR, creating a permanent link between the two transactions. When a retailer wishes to modify or query the status of a particular transaction, the retailer supplies the UTR in the request. The retailer will have received the UTR in the response message to the API call that originally created the transaction. The system may request UTRs supplied to it to be string objects with a maximum length of 256 characters. They may contain any non-control Unicode character. The system may generate UTRs with a length of 128 characters. They may contain any non-control Unicode character. For both XML-over-HTTP and SOAP endpoints, two types of responses may be returned from each API call: a “normal” response or a fault. Faults are returned to the caller if some pre-condition for calling the service is not met, or if some failure occurs during the request processing. A typical example is if the caller fails to supply authentication credentials, or if the credentials are incorrect. Normal responses are returned only if the call to the API endpoint is successful. In the case of SOAP end-points, faults may take the form of standard SOAP faults. For the XML-over-HTTP endpoints, a custom fault object is returned which closely mimics the structure of a SOAP fault.

In one embodiment, a retailer default reservation window or API requested over-ride is allocated. In another embodiment, a retailer default adult content flag or API requested product flag over-ride is allocated. In still another embodiment, no sequential letter in the alphabetical part of the unique payment code shares the same keypad key on a mobile device.

In one embodiment, a first server 106a receives an API call from a payee server 106b requesting a unique identifier for display on a payee merchant website operating independently of the first server 106a. For example, the first server 106a may generate a code specific to a shopping basket based on an API request from a retailer on the basis of alphanumeric conventions that ensure no repeat or adjacent usage. In another embodiment, the first server 106a generates, in real-time, from, by way of example, a bank of code “blocks”, a unique payment code, ensuring no repeat or adjacent usage. In still another embodiment, the first server 106a transmits the generated code via secure API for display at the payee merchant website. In still even another embodiment, the first server 106a receives, from a payor, an SMS message containing the unique payment code. In yet another embodiment, the first server 106a debits a payor virtual “wallet”, which has funds, for an amount corresponding to the value of the items identified within a payor's shopping basket; alternatively, where the payor has no funds or is a first time user, the first server 106a reserves the items identified by the shopping basket for a set period of time (default period 24 hrs) after which the transaction code will simply expire if the payor's virtual “wallet” has not been replenished to at least the value requested. In others of these embodiments, a payor wallet is auto-created when the first server 106a receives the unique payment code.

In some embodiments, the methods and systems described herein provide a unique checkout experience where the consumer transmits, via text message, a code unique to the consumer's shopping basket, to pay for or to reserve that shopping, depending on when they loads funds on their wallet. In one of these embodiments, the methods and systems described herein provide dynamic production of payment codes unique to each online shopping basket based on alpha numeric convention to ensure no immediate repeat or adjacent usage. In another of these embodiments, the methods and systems described herein provide allocation of those purchases to mobile number denominated wallets on receipt of a text message containing that payment code, even if no wallet existed prior to receipt of that text message, e.g. first time users. In still another of these embodiments, the methods and systems described herein provide confirmation of a transaction as paid or reserved subject to funds validation of wallet balance. In yet another of these embodiments, the methods and systems described herein provide subsequent auto-payment of reserved transactions if the consumer loads funds on their wallet within an allotted time frame.

In some embodiments, the methods and systems described herein provide mechanisms with which users may make contributions to charitable organizations. In other embodiments, the methods and systems described herein provide mechanisms with which users may receive cash back from organizations; for example, a user may receive credit from another user or an organization—including, without limitation, and by way of example only, money transfers from other users, rebates or incentives from retailers, or winnings from online gaming sites.

A client 102 and a server 106 (referred to generally as computing devices 100) can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. A client 102 may execute, operate or otherwise provide an application, which can be any type and/or form of software, program, or executable instructions such as any type and/or form of web browser, web-based client, client-server application, an ActiveX control, or a Java applet, or any other type and/or form of executable instructions capable of executing on client 102. The application can use any type of protocol and it can be, for example, an HTTP client, an FTP client, an Oscar client, or a Telnet client.

In some embodiments, the computing device 100 is a TREO 180, 270, 600, 650, 680, 700p, 700w/wx, 750, 755p, 800w, Centro, or Pro smart phone manufactured by Palm, Inc; the TREO smart phone is operated under the control of the PalmOS operating system and includes a stylus input device as well as a five-way navigator device. In other embodiments the computing device 100 is a mobile device, such as a JAVA-enabled cellular telephone or personal digital assistant (PDA), such as the i55sr, i58sr, i85s, i88s, i90c, i95c1, i335, i365, i570, I576, i580, i615, i760, i836, i850, i870, i880, i920, i930, ic502, ic602, ic902, i776 or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea.

In some embodiments, the computing device 100 is a mobile device manufactured by Nokia of Finland, or by Sony Ericsson Mobile Communications AB of Lund, Sweden. In still other embodiments, the computing device 100 is a Blackberry portable or smart phone, such as the devices manufactured by Research In Motion Limited, including the Blackberry 7100 series, 8700 series, 7700 series, 7200 series, the Blackberry 7520, the Blackberry PEARL 8100, the 8700 series, the 8800 series, the Blackberry Storm, Blackberry Bold, Blackberry Curve 8900, and the Blackberry Pearl Flip. In yet other embodiments, the computing device 100 is a smart phone, Pocket PC, Pocket PC Phone, or other portable mobile device supporting Microsoft Windows Mobile Software. Moreover, the computing device 100 can be any workstation, desktop computer, laptop or notebook computer, server, portable computer, mobile telephone, any other computer, or other form of computing or telecommunications device that is capable of communication and that has sufficient processor power and memory capacity to perform the operations described herein.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Inc., of Cupertino, Calif.

It should be understood that the systems described above may provide multiple ones of any or each of those components and these components may be provided on either a standalone machine or, in some embodiments, on multiple machines in a distributed system.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for reserving and completing purchases, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method of reserving and completing purchases, the method comprising:
transmitting, by a first computing device, a payment authorization code to a second computing device, the payment authorization code associated with an order placed by a user of the second computing device;
receiving, by a transaction management component executing on a third computing device, the payment authorization code from the second computing device;
requesting, by the transaction management component, from the user, a payment to complete the order within a time period;
determining, by the transaction management component, that the user provided the requested payment within the time period; and
instructing, by the transaction management component, a retailer transaction management component executing on the first computing device to fulfill the order, responsive to the determination.

2. The method of claim 1 further comprising receiving, by a code generation component executing on the third computer, from a code request component executing on the first computing device, a request for the payment authorization code.

3. The method of claim 1 further comprising receiving, by a code request component executing on the first computing device, from a code generation component executing on the third computing device, the payment authorization code.

4. The method of claim 1 further comprising transmitting, by the transaction management component, to the retailer transaction management component, a notification of receipt of the payment authorization code from the second computing device.

5. The method of claim 1 further comprising transferring, by the transaction management component, a subset of the requested payment to an account associated with an owner of the first computing device.

6. A system for reserving and completing purchases comprising:
a first computing device transmitting a payment authorization code to a second computing device, the payment authorization code associated with an order placed by a user of the second computing device; and
a transaction management component (i) executing on a third computing device, (ii) receiving, from the second computing device, the payment authorization code, (iii) requesting, from the user, a payment to complete the order within a time period, (iv) determining that the user provided the requested payment within the time period and (v) instructing a retailer transaction management component executing on the first computing device to fulfill the order, responsive to the determination.

7. The system of claim 6 further comprising a code request component executing on the first computing device and requesting, from the third computing device, the payment authorization code.

8. The system of claim 6 further comprising a code generation component executing on the third computing device, generating the payment authorization code, and transmitting the payment authorization code to the first computing device.

9. The system of claim 6 further comprising an account management component executing on the third computing device, receiving from the user of the second computing device account registration information and establishing a user account for the user responsive to the received account registration information.

10. The system of claim 6 further comprising an account management component executing on the third computing device, receiving from the user of the second computing device an identification of the second computing device as a device from which the user may access account information associated with the user and stored by the third computing device.

11. The system of claim 6 further comprising an account management component executing on the third computing device, receiving from the user of the second computing device an identification of a fourth computing device as a device from which the user may access account information associated with the user and stored by the third computing device.

12. The system of claim 11, wherein the account management component further comprises means for receiving information authenticating the fourth computing device to the third computing device.

13. A method of reserving and completing purchases, the method comprising:
receiving, by a transaction management component executing on a first computing device, a plurality of payment authorization codes from a user of a second computing device, each of the plurality of payment authorization codes associated with one of a plurality of orders placed by the user;
requesting, by the transaction management component, from the user, a payment for each of the plurality of orders within a time period;
determining, by the transaction management component, that the user provided the requested payment within the time period; and
directing, by the transaction management component, fulfillment of each of the plurality of orders, responsive to the determination.

14. A method of reserving and completing purchases, the method comprising:
receiving, by a transaction management component executing on a first computing device, a plurality of payment authorization codes from a user of a second computing device, each of the plurality of payment authorization codes associated with one of a plurality of orders placed by the user;
requesting, by the transaction management component, from the user, a payment for each of the plurality of orders within a time period;
determining, by the transaction management component, that the user provided a subset of the requested payment within the time period;
identifying, by the transaction management component, one of the plurality of orders that the subset of the requested payment is sufficient to complete; and
instructing, by the transaction management component, a retailer transaction management component associated with the identified one of the plurality of orders to fulfill the identified one of the plurality of orders, responsive to the identification.

15. The method of claim 14 further comprising applying an algorithm to identify the one of the plurality of orders that the subset of the requested payment is sufficient to complete.

16. The method of claim 14 further comprising:
identifying a second one of the plurality of orders that the subset of the requested payment is sufficient to complete; and
instructing, by the transaction management component, a retailer transaction management component associated with the identified second one of the plurality of orders to fulfill the identified second order responsive to the identification.

17. The method of claim 14 further comprising:
determining that the subset of the requested payment is insufficient to complete a second one of the plurality of orders; and
requesting, by the transaction management component, from the user, an additional payment for each unfulfilled order in the plurality of orders within a second time period.

18. A method of reserving and completing purchases, the method comprising:
receiving, by an account management component executing on a first computer, funding from a user for deposit into a user account;
transmitting, by a second computing device, a payment authorization code to a third computing device, the payment authorization code associated with a first order placed by the user;
receiving, by a transaction management component executing on the first computing device, the payment authorization code from the third computing device;
determining, by the transaction management component, that the funding in the user account is sufficient to pay for the first order;
instructing, by the transaction management component, a retailer transaction management component executing on the second computing device to fulfill the first order, responsive to the determination;
providing, by a fourth computing device, to the third computing device, a second payment authorization code associated with a second order placed by the user;
transmitting, by the third computing device, to the transaction management component, the second payment authorization code;
determining, by the transaction management component, that the funding in the user account is insufficient to pay for the second order;
requesting, by the transaction management component, from the user, additional funds to complete the second order within a time period;
determining, by the transaction management component, that the user provided the requested additional funds within the time period; and
instructing, by the transaction management component, a second retailer transaction management component executing on the fourth computing device to fulfill the second order, responsive to the determination.

19. The method of claim 18 further comprising operating, by a single retailer, the second computing device and the fourth computing device.

20. The method of claim 18 further comprising:
operating, by a first retailer, the second computing device; and
operating, by a second retailer, the fourth computing device.
